(19) United States
(12) Patent Application Publication
(10) Pub. No.: US 2003/0194299 A1
(43) Pub. Date: Oct. 16, 2003

(54) Processing system for semiconductor wafers

(76) Inventor: Woo Sik Yoo, Palo Alto, CA (US)

Correspondence Address: Theodore P. Lopez, MacPherson Kwok Chen & Heid LLP, 2402 Michelson Drive, Suite 210, Irvin, CA, 92612, US

(21) Appl. No.: 10/123,747

(22) Filed: Apr. 15, 2002

(51) Int. Cl. B65G 1/00; B65G 65/00

(52) U.S. Cl. 414/271

(57) ABSTRACT

A system and method are provided for semiconductor wafer processing. A wafer processing system includes a transfer chamber, a loadlock module connected to the transfer chamber, a plurality of processing modules vertically mounted in-line with the loadlock module, and a wafer transfer apparatus. The wafer transfer apparatus moves a wafer from the loadlock module to at least one of the plurality of processing modules where processing of the wafer takes place. The system and method of the present invention minimize the required clean room space while heightening process control.

### BACKGROUND OF THE INVENTION

1. Field of the Invention

This invention generally relates to semiconductor device fabrication, and more particularly to systems and methods for processing a semiconductor wafer.

2. Related Art

Fabrication facilities for processing semiconductor wafers into electronic devices typically consist of large buildings within which “clean rooms” of thousands of square feet of floor area are provided. The clean rooms contain the equipment within which the various semiconductor fabrication processes are carried out. Floor space in a semiconductor fabrication clean room and equipment area can typically be scarce and costly. Thus, it is highly desirable to have a wafer processing system which occupies minimal floor space.

Typically, wafer processing systems include horizontally integrated reactors and process modules (i.e., the modules are spread out horizontally). FIG. 1 shows a top view of a system 10 with horizontally integrated reactors 16, 18, 20, and 22. A disadvantage of a horizontally integrated system is that the total floor space occupied by the wafer processing system increases as more modules are added to the system.

To access the horizontally integrated modules of the processing system, robots employed to automate the movement of wafers between modules have been required to perform lateral movements, typically involving rotational movement. A disadvantage of requiring rotational movement of the robot is added complexity and greater susceptibility to malfunction with corresponding higher maintenance costs.

A further disadvantage of horizontally integrated systems is that the associated lateral movement of a robot forces the transfer chamber to occupy an increased footprint covering the entire movement of the robot. Any required lateral movement by the robot, as opposed to vertical movement, increases the footprint area of the transfer chamber.

For these reasons, what is needed is a system and method for processing a semiconductor wafer in a simple manner which occupies a minimum amount of valuable clean room floor space.

### SUMMARY

The present invention provides a system and method for using a semiconductor wafer processing system having a minimized footprint area. The wafer processing system can include a transfer chamber, a loadlock module, a plurality of vertically stacked processing modules, and at least one wafer transfer apparatus that can transfer a wafer from the loadlock module to the plurality of vertically stacked processing modules. Advantageously, vertically stacking the processing modules allows for minimal use of expensive clean room space. As described in detail below, the vertical stacking of processing modules is accomplished because of the reduced size of the processing modules. For example, processing modules may be less than 0.3 m in height.

In one aspect of the present invention, the wafer processing system includes a transfer chamber, a loadlock module coupled to the transfer chamber, a first processing module coupled to the transfer chamber, which is positioned above the loadlock module, a second processing module coupled to the transfer chamber and positioned below the loadlock module, and at least one wafer transfer apparatus that can move along a vertical axis to access each processing module above and below the loadlock module. Advantageously, the simple movements required of the wafer transfer apparatus in this system allow for minimization of transfer chamber footprint area, less maintenance costs, and greater control of wafer transfer apparatus movements.

In another aspect of the present invention, a method is provided for processing a wafer. The method includes providing a transfer chamber, providing a loadlock module operably coupled to the transfer chamber, providing a plurality of processing modules positioned vertically in-line with the loadlock module. The method further includes moving a wafer from the loadlock module to at least one of the plurality of processing modules using a wafer transfer apparatus.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 shows a top view of a typical wafer processing system with horizontally-integrated reactors;

FIG. 2 shows a side view of a wafer processing system in accordance with one embodiment of the present invention.

FIGS. 3A and 3B show a side view and a perspective view, respectively, of a loadlock module in accordance with one embodiment of the present invention.

FIG. 4 is a simplified illustration of a wafer transfer apparatus in accordance with one embodiment of the present invention.

FIGS. 5A to 5E are simplified illustrations of side views of the wafer processing system shown in FIG. 2 illustrating the movement of a wafer from a carrier in a loadlock module to a reactor using the wafer transfer apparatus of FIG. 4.

FIG. 6 illustrates an alternative embodiment of a wafer processing system in accordance with the present invention.

The use of similar reference numerals in different figures indicates similar or identical items.

### DETAILED DESCRIPTION

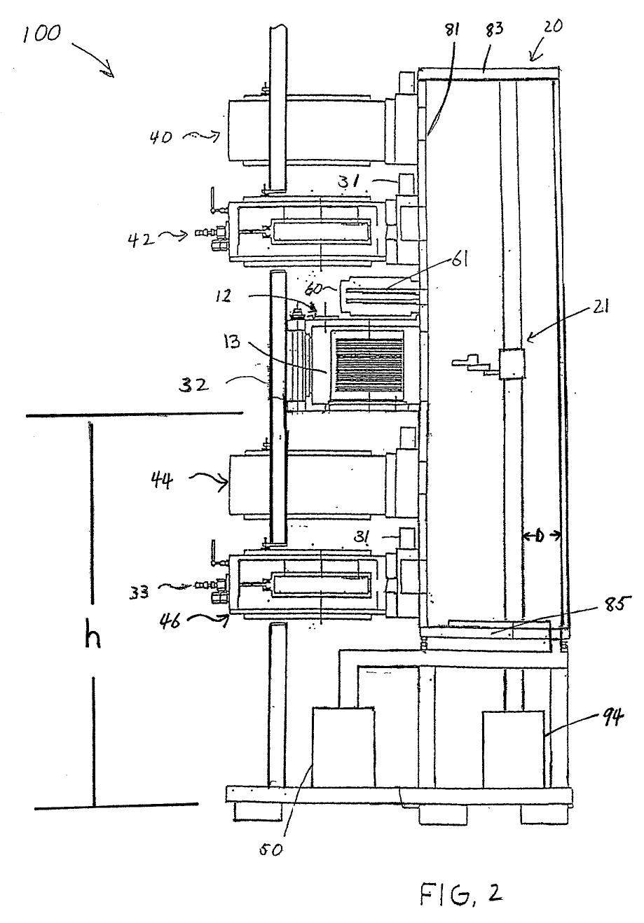

FIG. 2 shows a side view of a wafer processing system 100 in accordance with the present invention. System 100 includes a transfer chamber 20 housing a wafer transfer apparatus 21. A loadlock module 12, a cooling module 60, and processing modules 40, 42, 44, and 46 are operably connected to transfer chamber 20 along a common vertical axis.

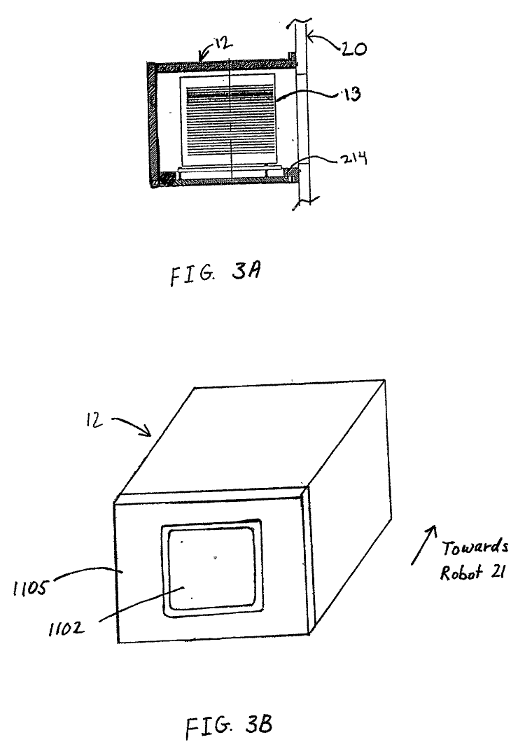

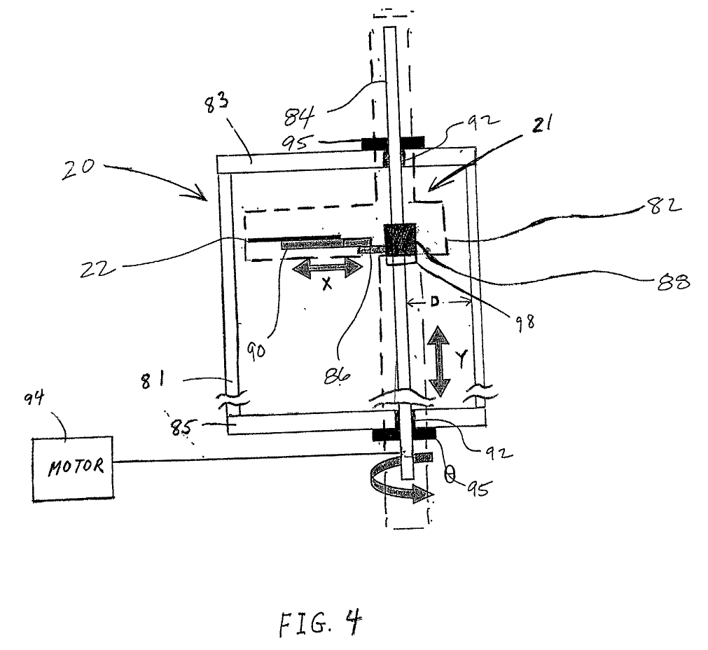

FIGS. 3A and 3B show a side view and a perspective view, respectively, of one embodiment of loadlock module 12. Typically, a wafer carrier is loaded into a loadlock of a processing system. Subsequently, a robot in a transfer chamber picks up a wafer from the carrier and moves the wafer into a reactor, also known as a process chamber.

In this embodiment, loadlock module 12 is bolted onto transfer chamber 20 housing a wafer transfer apparatus 21. Optionally, loadlock module 12 can include a viewing port 1102 on a side 1105 to allow visual inspection of the insides of loadlock module 12. Viewing port 1102 can be made of any transparent material, such as quartz, or any transparent material that can withstand wafer processing conditions.

In one embodiment, side 1105 is movably coupled to the other sides of loadlock module 12 by a slide mechanism or a hinge mechanism so that side 1105 may be temporarily moved to allow carrier 13 to be placed inside loadlock module 12.

In one embodiment, carrier 13 is a removable wafer carrier which can carry up to 25 or 26 wafers at a time. Wafer carrier 13 can be loaded into loadlock module 12 either manually or by using automated guided vehicles (“AGV”). However, the invention is not limited to the use of a specific type of loadlock module or substrate carrier. For example, any loadlock module may be used which is adapted to receive a wafer loading apparatus, such as a fixed wafer carrier, a front opening unified pod (“FOUP”), or a flat panel display cassette. In one embodiment, the fixed wafer carrier is an open cassette for loading wafers having a diameter of 200 mm or less, and the front opening unified pod allows loading of 300 mm wafers.

Referring once again to FIG. 2, in one embodiment, processing modules 40, 42, 44, and 46 can be rapid thermal processing (“RTP”) reactors. However, the invention is not limited to the use of a specific type of reactor and any semiconductor processing module may be used, such as those used in physical vapor deposition, etching, chemical vapor deposition (CVD) including thermal CVD and plasma enhanced CVD, cooling, heat treatment, stripping, sputtering, and ashing.

In accordance with the present invention, processing modules 40 and 42 and processing modules 44 and 46 are mounted above and below loadlock module 12, respectively, to minimize floor space occupied by system 100. Floor space is conserved by vertically stacking modules 40, 42, 44, and 46 in-line with loadlock module 12 along a common vertical axis. For example, the vertical axis is defined by transfer chamber wall 81 in FIG. 2. The present invention is not limited to a specific number of modules, thus any number of processing modules can be vertically mounted in-line above and below loadlock module 12. Processing modules 40, 42, 44, and 46 are bolted onto transfer chamber 20 and are further supported by a support frame 32. Process gases, coolant, and electrical connections are provided through the rear end of the processing modules using interfaces such as interface 33.

In accordance with industry standards, such as those set by Semiconductor Equipment and Materials International (SEMI), a typical loadlock module 12 is positioned at a height h of approximately 0.9 m from the clean room floor. Typical processing modules in the semiconductor industry, such as those available from Applied Materials, Inc., Santa Clara, Calif., have heights ranging from approximately 0.6 m to approximately 0.9 m. Accordingly, vertical stacking of typical processing chambers is prohibited below a loadlock module positioned at a height in accordance with industry standards.

As shown in FIG. 2, in one embodiment of the present invention, the height of processing modules 44 and 46 is no greater than approximately 0.3 m for each processing module. This height allows processing modules to be vertically mounted below loadlock module 12 positioned at a height h of approximately 0.9 m from the clean room floor. One type of processing module is disclosed in commonly-owned U.S. Pat. No. 6,303,906, issued Oct. 16, 2001, entitled “Resistively Heated Single Wafer Furnace,” which is incorporated herein by reference in its entirety.

In accordance with the invention, transfer chamber 20 is provided to house wafer transfer apparatus 21, which transports wafers to and from the modules of system 100, such as processing modules 40, 42, 44, and 46, cooling module 60, and loadlock module 12.

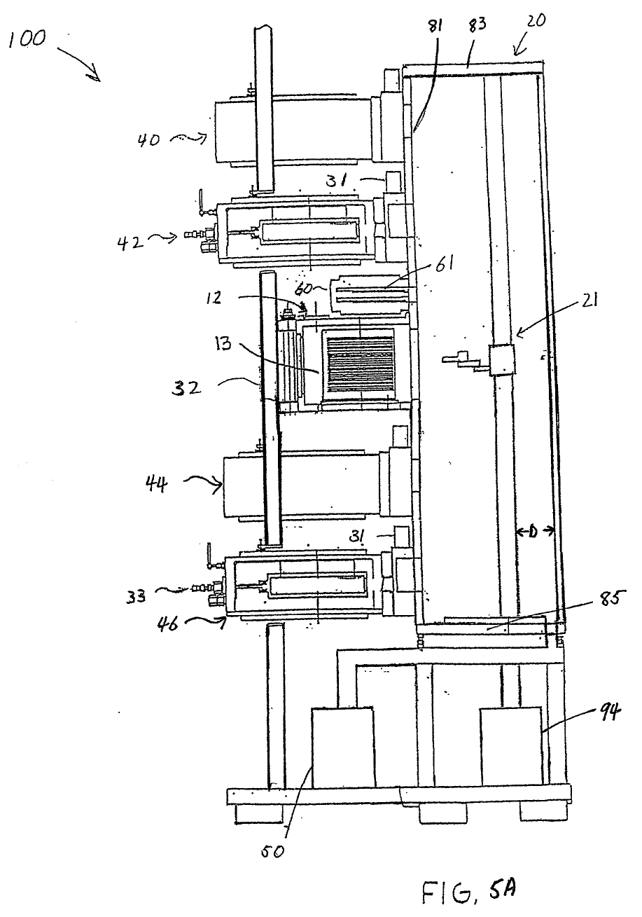

As is evident from FIGS. 2 and 4, transfer chamber 20 occupies just enough space to accommodate wafer transfer apparatus 21. Further, the reduced motion required of wafer transfer apparatus 21, as described in more detail below, allows minimization of the transfer chamber footprint, thereby saving floor space.

FIG. 4 shows an embodiment of wafer transfer apparatus 21. Wafer transfer apparatus 21 includes a wafer handling mechanism 82 and a driver member 84. Wafer handling mechanism 82 can include a robot arm 86 operably coupled to a linear movement actuator 88. Typically, at the end of robot arm 86 is an end effector 90 for picking up and/or grabbing wafer 22.

In one embodiment, driver member 84 is a threaded member, which can operate as a worm drive or lead screw drive. A top portion of driver member 84 is mounted through the top of transfer chamber 20 by a combination of a roller bearing 92 and a seal 95 or similarly functioning bearing/seal combination that provides smooth linear translation in direction Y and smooth rotation in direction θ. A bottom portion of driver member 84 is similarly mounted using roller bearing 92. Bearings 92 are well known and the function of bearings is well understood by those of ordinary skill in the art.

Seals 95 ensure that the internal environment of transfer chamber 20 and system 100 is unaffected by the movement of driver member 84. Seals 95 can be any type of seal which does not expand and compress with a moving part being moved through it. For example, seals 95 can be o-rings, lip-seals, or t-seals, such as the type of seals available from Sierracin Corporation of Sylmar, Calif.

A direction Y (i.e., vertical motion) motor/controller 94 (hereinafter “driver motor”), can be used to cause handling mechanism 82 to move in the Y direction above or below loadlock module 12. Driver motor 94 may be any typical drive motor, such as is available from Yaskawa Electric of Fukuoka, Japan. In this embodiment, driver motor 94 is mechanically coupled directly to threaded driver member 84 via a belt system, a gear system or similarly conventional power transmission means. A collar 98 is operably coupled to handling mechanism 82, such that as driver member 84 rotates θ, collar 98 rides up (or down), causing handling mechanism 82 to move up (or down) in the Y direction to gain access to all of the processing modules of the system.

In one embodiment, handling mechanism 82 can move from transfer chamber floor 85 to transfer chamber roof 83. For example, handling mechanism 82 can move from approximately 2.0 m above loadlock module 12 to approximately 1.0 m below loadlock module 12.

Movement of handling mechanism 82 in the horizontal X direction is accomplished by extending robot arm 86 with end effector 90 attached thereto. Robot arm 86 and end effector 90 are operably coupled to a linear movement actuator 88. For example, the extension and retraction of robot arm 86 and end effector 90 along a straight line can be accomplished using a conventional belt and pulley arrangement operably coupled to a linear motor. The linear motor is available from Yaskawa Electric. Alternatively, handling mechanism 82 may comprise any robot assembly capable of horizontal motion and transfer of wafers.

End effector 90 can be made of any heat resistant material, such as quartz, for picking up and placing wafer 22. Inlets may be provided to allow a coolant to flow to wafer transfer apparatus 21 during high temperature processing such as RTP. Any conventional coolant may be used including water, alcohol, and cooled gas. The use of internal cooling and a heat resistant end effector in wafer transfer apparatus 21 decreases the processing time of system 100 as wafer transfer apparatus 21 can transport a wafer in and out of a reactor without waiting for the reactor or the wafer to cool down. End effectors and robot arms are well known and their function well understood by those of ordinary skill in the art.

By providing vertical integration of all the system modules, wafer transfer apparatus 21 is simplified to two-axis linear movements. Limiting movement to vertical and extension motions further minimizes the footprint area of the transfer chamber as no space is required to cover any rotational wafer transfer movement. As illustrated in FIG. 4, the horizontal distance D, measured from driver member 84 to the wall of transfer chamber 20 opposite loadlock module 12, is minimized. In addition, the total transfer chamber footprint area is minimized to range from approximately 0.04 m² to 4.0 m².

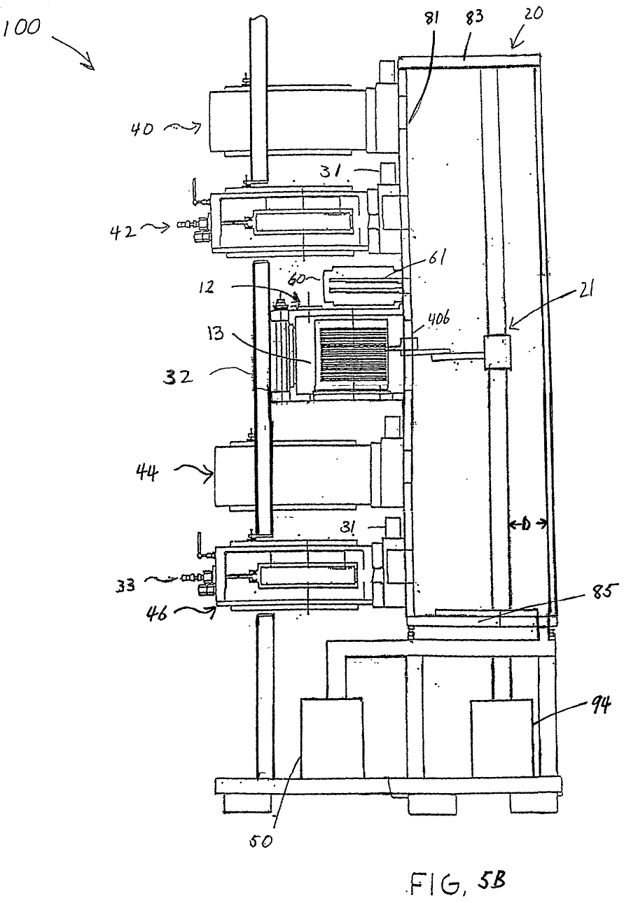

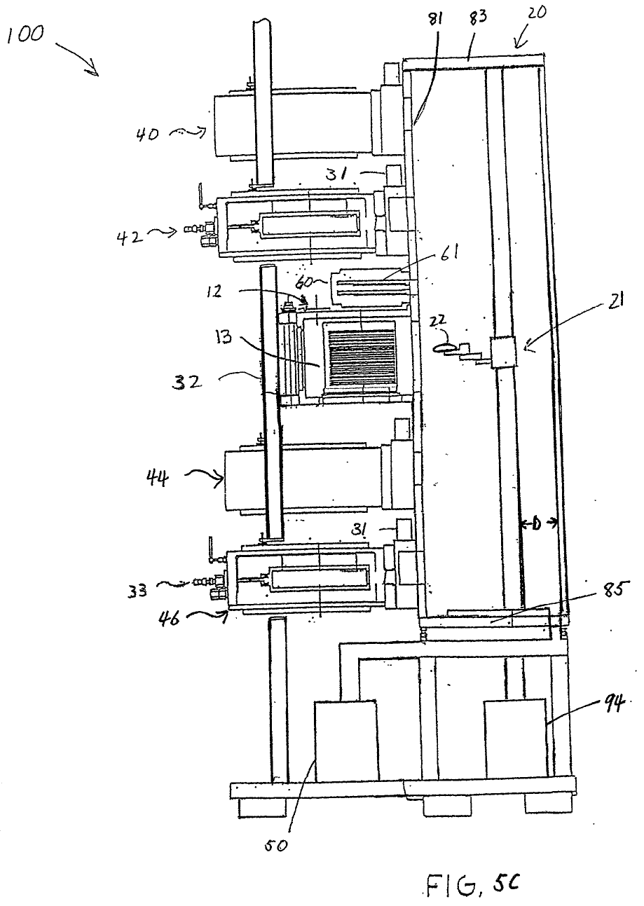

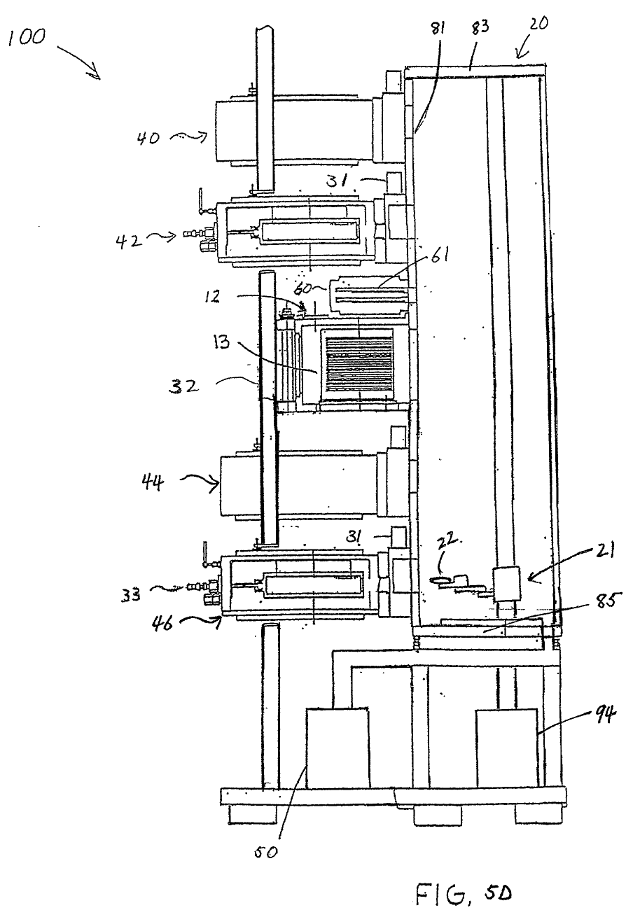

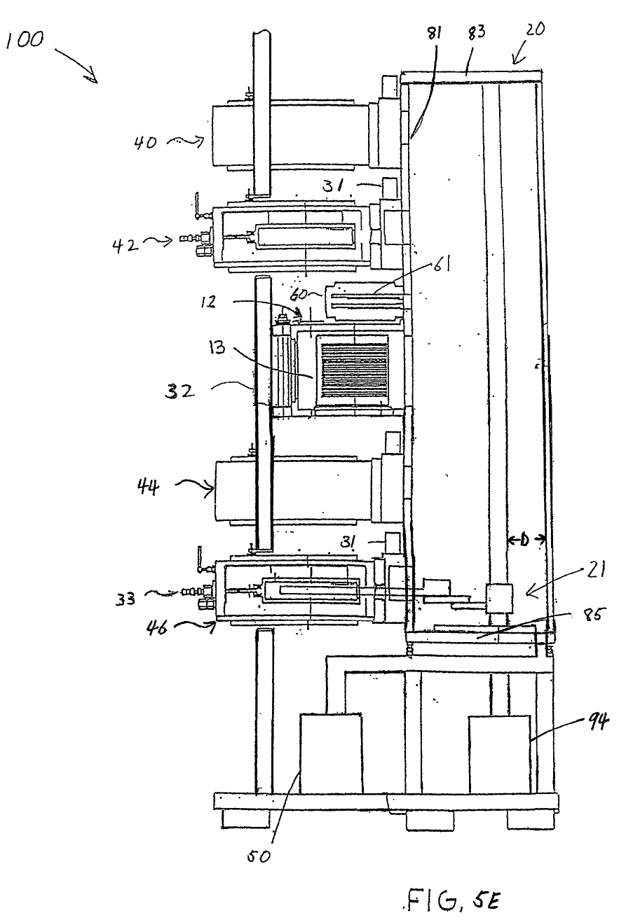

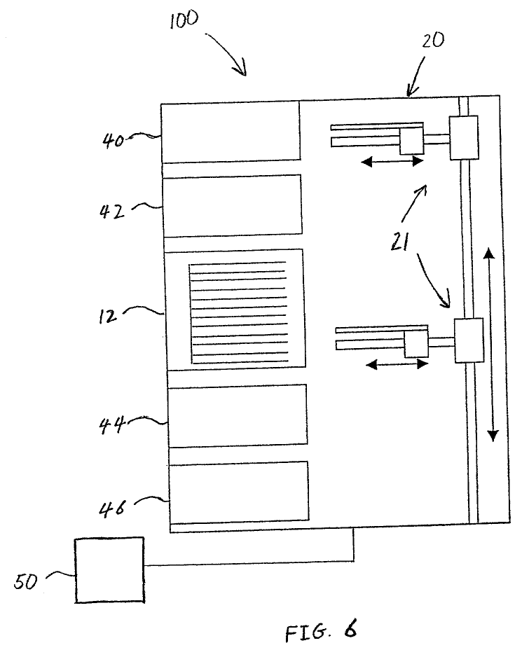

FIGS. 5A to 5E show side views of system 100 illustrating the movement of a wafer 22 from carrier 13, which is inside loadlock module 12, to a processing module 46 vertically stacked below loadlock module 12. It should be understood that movement of a wafer to other processing modules would be accomplished using movements similar to those described with regard to module 46.

Once carrier 13 is inside loadlock module 12, wafer transfer apparatus 21 in transfer chamber 20 lowers toward loadlock module 12 (FIG. 5A). Wafer transfer apparatus 21 extends end effector 406 to pick up wafer 22 from wafer carrier 13 (FIG. 5B). Wafer transfer apparatus 21 then retracts with wafer 22 (FIG. 5C), lowers to a position in-line with processing module 46 (FIG. 5D), and places wafer 22 into processing module 46 through a gate valve 31 (FIG. 5E). Wafer transfer apparatus 21 then retracts and, subsequently, gate valve 31 closes to begin the processing of wafer 22.

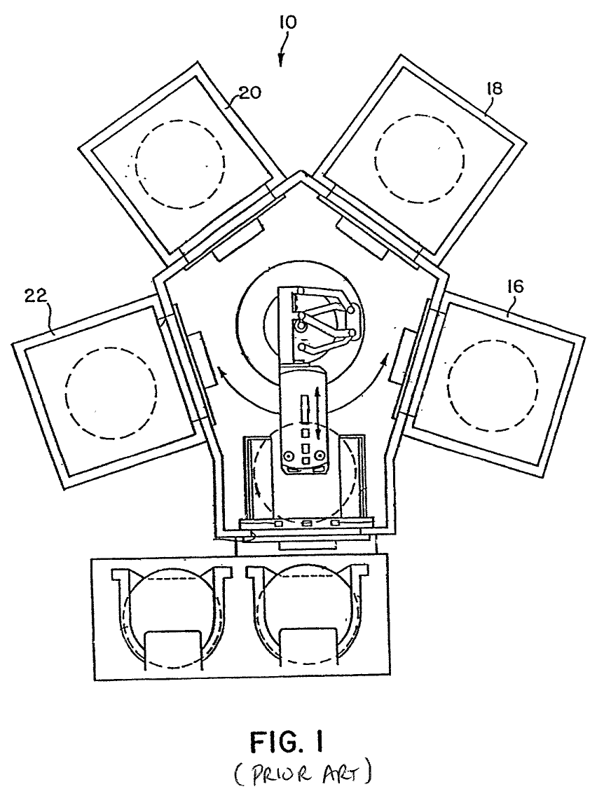

After wafer 22 is processed in a well known manner inside processing module 46, gate valve 31 opens to allow wafer transfer apparatus 21 to move wafer 22 into another processing module or finally cooling module 60 (FIG. 1). Because newly processed wafers may have temperatures upwards of 200° C. and could melt or damage a typical wafer carrier, cooling module 60 is provided for cooling the wafers before placing them back into a wafer carrier in loadlock module 12. In this embodiment, cooling module 60 is vertically mounted above loadlock module 12 to minimize the floor space area occupied by system 100. However, the invention is not limited to this particular configuration and cooling module 60 may be vertically mounted below loadlock module 12.

Cooling module 60 includes shelves 61, which may be liquid-cooled, to support multiple wafers at a time. While two shelves are shown in this embodiment, a different number of shelves can be used, if appropriate, to increase throughput. Subsequently, wafer 22 is transported from cooling module 60 and replaced to its original slot in carrier 13 using wafer transfer apparatus 21.

Referring again to FIG. 2, a pump 50 is provided for use in processes requiring vacuum. In the case where the combined volume of the processing modules is much less than the combined volume of loadlock module 12, cooling module 60, and transfer chamber 20, a single pump 50 may be used to pump down the entire volume of system 100 (i.e. combined volume of loadlock module 12, cooling module 60, transfer chamber 20, and processing modules 40-46) to vacuum. Otherwise, additional pumps may be required to separately pump down the processing modules. In this particular embodiment, a single pump 50 suffices because the combined volume of the processing modules is negligible compared to the entire volume of system 100, and thus the processing modules do not significantly affect the pressure within system 100.

FIG. 6 illustrates an alternative embodiment of a wafer processing system 100 in accordance with the present invention. In this embodiment, processing modules 40, 42, 44, 46 and loadlock module 12 are housed inside transfer chamber 20 to advantageously control for atmospheric and low pressure operations with pump 50. Further, in one embodiment, wafer processing system 100 may include more than one wafer transfer apparatus 21 for simultaneous processing of multiple wafers and to increase throughput.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as falling within the true spirit and scope of this invention.

What is claimed is:

1. A wafer processing system comprising:
a transfer chamber;
a first loadlock module operably coupled to the transfer chamber;
a plurality of processing modules operably coupled to the transfer chamber, wherein the plurality of processing modules are vertically mounted in-line with the first loadlock module; and
at least one wafer transfer apparatus having extension and vertical motion operable to transfer a wafer from the loadlock module to the plurality of processing modules.

2. The wafer processing system of claim 1, wherein the transfer chamber occupies a footprint area ranging from approximately 0.04 m² to approximately 4.0 m².

3. The processing system of claim 1, wherein the first loadlock module is adapted to receive a substrate carrier selected from the group consisting of a wafer cassette, a front opening unified pod, and a flat panel display cassette.

4. The processing system of claim 1, wherein at least one of the plurality of processing modules is vertically mounted in-line above the first loadlock module.

5. The processing system of claim 1, wherein at least one of the plurality of processing modules is vertically mounted in-line below the first loadlock module.

6. The processing system of claim 5, wherein the at least one of the plurality of processing modules vertically mounted below the first loadlock module comprises a height below approximately 0.3 m.

7. The processing system of claim 1, wherein at least one of the plurality of processing modules performs a process selected from the group consisting of chemical vapor deposition, physical vapor deposition, etching, heat treatment, cooling, stripping, and sputtering on a wafer substrate.

8. The processing system of claim 1, wherein at least one of the plurality of processing modules comprises a rapid thermal processor.

9. The processing system of claim 1, wherein the at least one wafer transfer apparatus comprises:
a robot arm;
a robot body; and
a driver member engaged at a top end and a bottom end of the transfer chamber, the robot arm and the robot body being movable along said driver member.

10. The processing system of claim 9, wherein the robot arm is configured to move a semiconductor wafer to a processing module.

11. The processing system of claim 1, wherein the transfer chamber, the first loadlock module, and the plurality of processing modules are coupled to a pumping system for establishing a desired pressure within each apparatus.

12. A wafer processing system comprising:
a transfer chamber;
a first loadlock module operably coupled to the transfer chamber;
a first processing module operably coupled to the transfer chamber, wherein the first processing module is vertically mounted in-line above the first loadlock module;
a second processing module operably coupled to the transfer chamber, wherein the second processing module is vertically mounted in-line below the first loadlock module; and
at least one wafer transfer apparatus capable of motion along a vertical axis, wherein the motion along a vertical axis can extend to above and to below the first loadlock module.

13. The wafer processing system of claim 12, wherein the transfer chamber occupies a footprint area ranging from approximately 0.04 m² to approximately 4.0 m².

14. The wafer processing system of claim 12, wherein the motion along a vertical axis can extend to the roof of the transfer chamber and to the floor of the transfer chamber.

15. The wafer processing system of claim 12, wherein the motion along a vertical axis can extend from approximately 2.0 m above the loadlock module to approximately 1.0 m below the loadlock module.

16. The wafer processing system of claim 12, wherein the wafer transfer apparatus is further capable of extension motion.

17. A method for processing a semiconductor wafer comprising:
providing a transfer chamber;
providing a first loadlock module operably coupled to the transfer chamber;
providing a plurality of processing modules vertically mounted in-line with the first loadlock module;
moving a wafer from the loadlock module into at least one of the plurality of processing modules using a wafer transfer apparatus; and
processing the wafer.

18. The method for processing a semiconductor wafer as in claim 17, wherein at least one of the plurality of processing modules is vertically mounted in-line below the first loadlock module.

19. The method for processing a semiconductor wafer as in claim 17, wherein processing of the wafer is selected from the group consisting of chemical vapor deposition, physical vapor deposition, etching, heat treatment, cooling, stripping, and sputtering on a substrate.

20. The method for processing a semiconductor wafer as in claim 17, wherein the wafer transfer apparatus comprises:
a robot arm;
a robot body; and
a driver member engaged at a top end and a bottom end of the transfer chamber, the robot arm and the robot body being movable along the driver member.

21. The method for processing a semiconductor wafer as in claim 17, further comprising placing a carrier into the loadlock module, wherein the carrier is selected from the group consisting of a wafer cassette, a front opening unified pod, and a flat panel display cassette.
